(19) United States
(12) Patent Application Publication
(10) Pub. No.: US 2016/0011533 A1
(43) Pub. Date: Jan. 14, 2016

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Satomi HARA, Kanagawa (JP); Atsushi SUGITATE, Kanagawa (JP); Masaru TAKAHASHI, Kanagawa (JP); Shotaro TAKAHASHI, Kanagawa (JP); Sakiko HIRAI, Kanagawa (JP)

(73) Assignee: FUJI XEROX CO., LTD., Tokyo (JP)

(21) Appl. No.: 14/593,141

(22) Filed: Jan. 9, 2015

(30) Foreign Application Priority Data
Jul. 14, 2014 (JP) 2014-144254

(51) Int. Cl. G03G 9/00

(52) U.S. Cl. CPC G03G 9/09342; G03G 9/0902; G03G 9/08733; G03G 9/0819; G03G 9/0825

(57) ABSTRACT

An electrostatic charge image developing toner includes toner particles containing an aluminum pigment that is coated with silica and a binder resin, wherein the following formula is satisfied:

A/B≦0.040

where A represents a content (atom %) of a Si element of the toner particles and B represents a content (atom %) of a C element of the toner particles, A and B being measured by X-ray photoelectron spectroscopy (XPS).

### CROSS-REFERENCE TO RELATED APPLICATIONS

This application is based on and claims priority under 35 USC 119 from Japanese Patent Application No. 2014-144254 filed Jul. 14, 2014.

### BACKGROUND

1. Technical Field

The present invention relates to an electrostatic charge image developing toner, an electrostatic charge image developer, and a toner cartridge.

2. Related Art

A brilliant toner has been used for the purpose of forming an image having brilliance such as metallic gloss.

### SUMMARY

According to an aspect of the invention, there is provided an electrostatic charge image developing toner, comprising:

toner particles containing an aluminum pigment that is coated with silica and a binder resin, wherein the following formula is satisfied:

A/B≦0.040

where A represents a content (atom %) of a Si element of the toner particles and B represents a content (atom %) of a C element of the toner particles, A and B being measured by X-ray photoelectron spectroscopy (XPS).

### BRIEF DESCRIPTION OF THE DRAWINGS

Exemplary embodiments of the present invention will be described in detail based on the following figures, wherein:

FIG. 1 is a cross-sectional view schematically showing a toner according to the exemplary embodiment;

FIG. 2 is a schematic configuration view showing an image forming apparatus according to the exemplary embodiment; and

FIG. 3 is a schematic configuration view showing an example of a process cartridge according to the exemplary embodiment.

### DETAILED DESCRIPTION

Hereinafter, an electrostatic charge image developing toner, a production method therefor, an electrostatic charge image developer, a toner cartridge, a process cartridge, an image forming apparatus, and an image forming method of the exemplary embodiment will be described in detail.

Electrostatic Charge Image Developing Toner and Production Method Therefor

The electrostatic charge image developing toner (hereinafter, referred to as the toner according to the exemplary embodiment in some cases) according to the exemplary embodiment is a toner which contains toner particles including an aluminum pigment (hereinafter, referred to as a specific aluminum pigment in some cases) which is coated with silica and a binder resin, and in which the ratio (A/B) of a content A (atom %) of a Si element of the toner particles to a content B (atom %) of a C element of the toner particles measured by X-ray photoelectron spectroscopy (XPS) is equal to or less than 0.040.

The toner according to the exemplary embodiment has excellent electrical characteristics and transfer characteristics. The reason for this is not clear, however, it is thought to be as follows. In the aluminum pigment used in the toner according to the exemplary embodiment, since an aluminum base material and silica which is a coating base material have high electric conductivity, in a case where the pigment is not encapsulated and due to this, when exposed, electric charge leakage is likely to occur, and electrical characteristics deteriorate. As a result, a charged quantity distribution is increased, and due to this, the amount of toner which does not transfer is increased, and transfer characteristics deteriorate. Based on the above description, it is considered that, in the toner according to the exemplary embodiment, by preventing the exposure of the aluminum base material to the toner surface, it is possible to prevent the charge leakage, and electrical characteristics become favorable. Moreover, the reason for coating the aluminum pigment with silica is to improve adhesiveness between the aluminum pigment and a resin, and to improve chemical resistance during toner granulation. Specifically, it is considered that this is because originally, there is no affinity between the aluminum pigment and the resin particles, and as a result, the aluminum pigment is likely to be exposed on the surface of the toner, however, silica has higher affinity for the resin and increases the apparent surface area of the aluminum pigment, and as a result, the resin particles are more likely to be attached to the surface of the aluminum, pigment.

In the toner exhibiting brilliance, the specific aluminum pigment which is a metallic pigment is used as a pigment, since it expresses high brilliance exhibiting a high reflection on the smooth flake surface.

However, in the toner prepared by using the specific aluminum pigment, in the related art, transfer current at the time of transfer under high temperature and high humidity is injected into the toner, and thus transfer efficiency deteriorates. As the cause, it is considered that since a pigment particle diameter is large, there is a problem of pigment encapsulation into the toner, and since electrical characteristics of the toner deteriorate by the influence due to the presence of a pigment which is not coated with the binder resin, transfer property is poor compared to the toner which does not include a metallic pigment, and since the binder resin is less likely to be attached to the surface of the specific aluminum pigment, there is a problem of pigment encapsulation into the toner.

In the exemplary embodiment, the ratio (A/B) of the content A (atom %) of a Si element of toner particles to the content B (atom %) of a C element of toner particles measured by X-ray photoelectron spectroscopy (XPS) is equal to or less than 0.040. Here, the C element included in the toner particles is a component derived from silica with which the aluminum pigment is coated. On the other hand, the Si element included in the toner particles is a component derived from the binder resin. For this reason, the ratio (A/B) regulates the extent of exposure of the specific aluminum pigment on the toner particle surface. When the ratio (A/B) is equal to or less than 0.040, exposure of the specific aluminum pigment on the toner particle surface is suppressed to the extent that deterioration of the electrical characteristics of the toner is prevented. As a result, it is considered that the toner according to the exemplary embodiment becomes excellent in electrical characteristics and transfer characteristics.

The content A and the content B measured by XPS are values obtained by using JPS-9000MX, manufactured by JEOL Ltd., as a measuring device and a MgKα line as an X-ray source, and by setting the acceleration voltage to 10 kV and the emission current to 30 mA.

In a case where an external additive is attached to the surfaces of the toner particles, when determining the content A (atom %) of a Si element and the content B (atom %) of a C element of the toner particles, it is preferable to remove the external additive attached to the surfaces of the toner particles. Specifically, a few drops of a surfactant such as Contaminon (manufactured by Wako Pure Chemical Industries, Ltd.) are added to ion exchange water, and the toner is added thereto, then, the mixture is dispersed, and irradiated with ultrasonic waves for from 1 minute to 5 minutes, whereby the external additive attached to the surfaces of the toner particles is removed. Thereafter, a dispersion of the toner is passed through a filter paper, and after rinsing, the toner particles on the filter paper are dried, and an XPS measurement is performed.

Although in the exemplary embodiment, the ratio (A/B) of the content A (atom %) of a Si element of the toner particles to the content B (atom %) of a C element of the toner particles is equal to or less than 0.040, the ratio (A/B) is preferably equal to or less than 0.020, more preferably equal to or less than 0.010, and still more preferably substantially 0. When the ratio (A/B) is greater than 0.040, electrical characteristics of the toner may deteriorate.

In the toner according to the exemplary embodiment, it is preferable that the following formula is satisfied:

2≦X/Y≦100

where X represents a reflectance at a light-receiving angle of +30° and Y represents a reflectance at a light-receiving angle of −30°, X and Y being measured when a solid image formed by the toner is irradiated with an incident light having an incident angle of −45° using a goniophotometer.

That is, in a case of forming a solid image, the ratio (X/Y) of a reflectance X at a light-receiving angle of +30° to a reflectance Y at a light-receiving angle of −30° measured when an incident light having an incident angle of −45° is irradiated with respect to the image using a goniophotometer is preferably from 2 to 100.

The fact that the ratio (X/Y) is equal to or greater than 2 represents that reflectance to the opposite side (plus-angle side) to the side on which an incident light is incident is greater than reflectance to the side (minus-angle side) on which an incident light is incident, that is, represents that irregular reflection of the light incident is prevented. In a case where irregular reflection in which the light incident is reflected in various directions occurs, the color appears dull when visually observing the reflected light. Therefore, in a case where the ratio (X/Y) is less than 2, there is a case that glossiness may not be confirmed, and brilliance is poor when viewing the reflected light,

In contrast, when the ratio (X/Y) is greater than 100, there is a case where a viewing angle capable of visually recognizing the reflected light becomes too narrow, and the color appears black depending on the viewing angle since a specular reflection light component is large. In addition, a toner of which the ratio (X/Y) is greater than 100 is less likely to be prepared.

Furthermore, the above ratio (X/Y) is preferably from 50 to 100, more preferably from 60 to 90, and particularly preferably from 70 to 80.

Measurement of Ratio (X/Y) by Goniophotometer

Here, first, the incident angle and the light-receiving angle will be described. In a measurement by a goniophotometer in the exemplary embodiment, an incident angle of −45° is used, and this is because measurement sensitivity is high with respect to an image having a wide glossiness range.

In addition, light-receiving angles of −30° and +30° are used, and this is because measurement sensitivity is most high when evaluating an image with a bright feeling and an image without a bright feeling.

Then, a method for measuring the ratio (X/Y) will be described.

In the exemplary embodiment, when measuring the ratio (X/Y), first, a “solid image” is formed by the following method. A developing device DocuCentre-III C7600, manufactured by Fuji Xerox Co., Ltd. is filled with the developer as a sample and a solid image having a toner applied amount of 4.5 g/cm² is formed on a recording sheet (OK topcoat+paper manufactured by Oji Paper Co., Ltd.) at a fixing temperature of 190° C. and a fixing pressure of 4.0 kg/cm². Furthermore, the “solid image” refers to an image having a printing rate of 100%.

Using a spectroscopic variable angle photometer GC 5000L, manufactured by Nippon Denshoku Industries Co., Ltd., as a goniophotometer, an incident light is incident at an incident angle of −45° to the solid image, and a reflectance X at a light-receiving angle of +30° and a reflectance Y at a light-receiving angle of −30° are measured with respect to an image portion of the formed solid image. Furthermore, measurements of the reflectance X and the reflectance Y are performed on light in a wavelength range from 400 nm to 700 nm at 20 nm intervals, and an average value of a reflectance at each wavelength is used. From these measurement results, the ratio (X/Y) is calculated.

Configuration of Toner

The toner according to the exemplary embodiment preferably satisfies the following requirements (1) and (2) from the viewpoint of satisfying the above ratio (X/Y).

(1) An average equivalent circle diameter D is larger than an average maximum thickness C of the toner.

(2) In a case where a cross section in the thickness direction of the toner is observed, the number of a metallic pigment in which an angle between the long axis direction on a cross section of the toner and the long axis direction of the metallic pigment is within a range from −30° to +30° is equal to or greater than 60% in the entirety of metallic pigments observed.

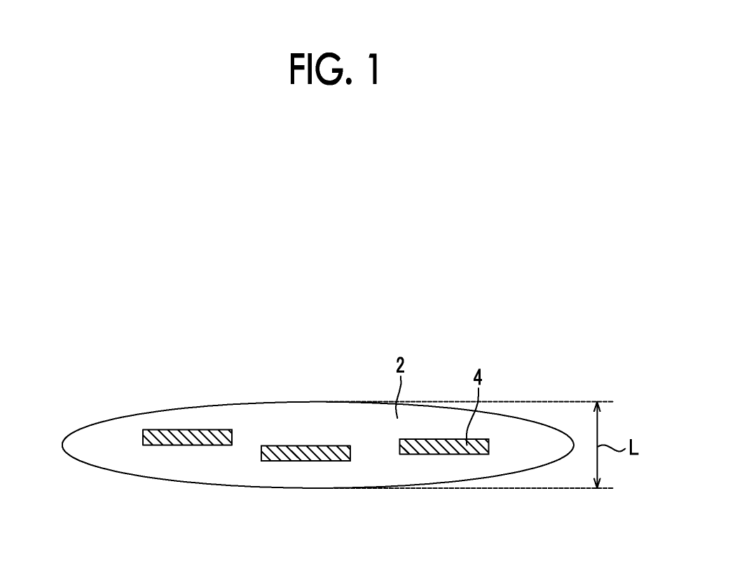

Here, in FIG. 1, a cross-sectional view schematically showing the toner satisfying the above requirements (1) and (2) is shown. Furthermore, the schematic view shown in FIG. 1 is a cross-sectional view in the thickness direction of the toner.

A toner 2 shown in FIG. 1 is a toner having a flake shape in which the equivalent circle diameter is larger than the thickness L, and contains a metallic pigment 4 having a flake shape.

As shown in FIG. 1, it is considered that when the toner 2 has a flake shape in which the equivalent circle diameter is larger than the thickness L, in a developing step or a transfer step of image formation, the toner tends to move so as to cancel as much as possible the charge of the toner when the toner moves to an image holding member, an intermediate transfer member, a recording medium, or the like, and thus, the toner is arranged such that the area attached is in a maximum. That is, it is considered that the toner having a flake shape is arranged on the recording medium to which the toner is finally transferred, such that the flake surface side thereof faces the surface of the recording medium. In addition, it is considered that in the fixing step of image formation, by the pressure at the time of fixing, the toner having a flake shape is arranged such that the flake surface side thereof faces the surface of the recording medium.

Therefore, it is considered that a metallic pigment satisfying a requirement of “an angle between the long axis direction on a cross section of the toner and the long axis direction of the metallic pigment is within a range from −30° to +30°” shown in the above (2) among the metallic pigments having a flake shape contained in the toner is arranged such that the surface side having the maximum area faces the surface of the recording medium. It is considered that in a case where an image formed in this manner is irradiated with light, the proportion of the metallic pigment irregularly reflecting with respect to the incident light is prevented, and thus, the above-described range of the ratio (X/Y) is achieved. In addition, when the proportion of the metallic pigment irregularly reflecting with respect to the incident light is prevented, the intensity of the reflected light varies greatly depending on the viewing angle, and thus, a more ideal brilliance is obtained.

Next, components configuring the toner according to the exemplary embodiment will be described.

The toner according to the exemplary embodiment is configured to include toner particles, and as necessary, an external additive.

For example, the toner particles are configured to include a metallic pigment including the specific aluminum pigment and a binder resin, and as necessary, a release agent and other additives.

Metallic Pigment

As one metallic pigment used in the exemplary embodiment, the aluminum pigment is used.

In the aluminum pigment, the coating amount of silica with respect to the aluminum pigment is preferably from 16.00 parts by weight to 22.00 parts by weight, more preferably from 17.00 parts by weight to 21.00 parts by weight, and still more preferably from 19.00 parts by weight to 20.50 parts by weight with respect to 100 parts by weight of the aluminum pigment.

In the aluminum pigment, the coating thickness of silica with respect to the aluminum pigment is preferably from 1.5 nm to 5.0 nm, more preferably from 2.0 nm to 4.0 nm, and still more preferably from 2.5 nm to 3.0 nm.

Specific examples of the aluminum pigment used in the exemplary embodiment include 2173EA, 08-0076, FM4010, and the like manufactured by Toyo Aluminium K.K.

Moreover, as a specific manufacturing method of the aluminum pigment coated with silica, for example, after silica is mechanically implanted into the surface of the aluminum pigment, or the surface of the aluminum pigment is coated with silica, by further coating with a resin, the aluminum pigment coated with silica is manufactured.

In the exemplary embodiment, metallic pigments other than the specific aluminum pigment may be used in combination. As other metallic pigments, the followings may be used. Metallic powders such as an aluminum powder which is not coated with silica, a brass powder, a bronze powder, a nickel powder, and zinc powder may be exemplified.

In a case where a metallic pigment other than the specific aluminum pigment is used in combination as the metallic pigment, the content of the specific aluminum pigment in the metallic pigment is preferably from 40% by weight to 100% by weight, and more preferably from 60% by weight to 98% by weight.

The volume average particle diameter of the metallic pigment is preferably from 3 μm to 20 μm, and more preferably from 4.5 μm to 18 μm, and particularly preferably from 6 μm to 16 μm.

The content of the metallic pigment in the toner according to the exemplary embodiment is preferably from 1 part by weight to 70 parts by weight, and more preferably from 5 parts by weight to 50 parts by weight with respect to 100 parts by weight of a binder resin described below.

Binder Resin

As the binder resin, vinyl resins consisting of homopolymers of monomers such as styrenes (for example, styrene, parachlorostyrene, and α-methyl styrene), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (vinyl methyl ketone, vinyl ethyl ketone, and vinyl isopropenyl ketone), and olefins (for example, ethylene, propylene, and butadiene), or copolymers obtained by combining two or more types of these monomers may be exemplified.

Examples of the binder resin include non-vinyl resins such as an epoxy resin, a polyester resin, a polyurethane resin, a polyamide resin, a cellulose resin, a polyether resin, and modified rosin, mixtures of these and the above-described vinyl resins, or in the coexistence of these, graft polymers obtained by polymerizing vinyl monomers.

These binder resins may be used alone or in combination of two or more kinds thereof.

As the binder resin, a polyester resin is suitably used. As the polyester resin, a well-known polyester resin is used, for example.

Examples of the polyester resin include polycondensates of polyvalent carboxylic acids and polyols. Moreover, a commercially available product or a synthesized product may be used as the amorphous polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent alcohol having a crosslinked structure or a branched structure may be used in combination together with a diol. Examples of the tri- or higher-valent alcohol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

Moreover, the glass transition temperature is determined by a DSC curve obtained by differential scanning calorimetry (DSC), and more specifically, is determined by “an extrapolated starting temperature of glass transition” described in a method for determining a glass transition temperature of “transition temperature measuring method of plastic” in JIS K7121-1987.

The weight average molecular weight (Mw) of the polyester resin is preferably from 5,000 to 1,000,000, and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100, and more preferably from 2 to 60.

Moreover, the weight average molecular weight and the number average molecular weight are measured by Gel Permeation Chromatography (GPC). In the molecular weight measurement by GPC, GPC-HLC-8120 manufactured by Tosoh Corporation is used as a measurement apparatus, TSKgel Super HM-M (15 cm) manufactured by Tosoh Corporation is used as a column, and a THF solvent is used. The weight average molecular weight and the number average molecular weight are calculated using a molecular weight calibration curve prepared by monodisperse polystyrene standard samples from the measurement results.

As the production method of the polyester resin, a well-known production method is used, for example. Specific examples thereof include a method of conducting a reaction at a polymerization temperature set to 180° C. to 230° C., if necessary, under a reduced pressure in the reaction system, while removing water or alcohol generated during condensation.

In a case where monomers of the raw materials are not dissolved or compatibilized at a reaction temperature, a high-boiling-point solvent may be added as a solubilizing agent to dissolve the monomers. In this case, a polycondensation reaction is performed while distilling off the solubilizing agent. In a case where a monomer having poor compatibility is present in a copolymerization reaction, the monomer having poor compatibility and an acid or an alcohol to be polycondensed with the monomer may be previously condensed and then, polycondensed with the main component.

The content of the binder resin, for example, is preferably from 40% by weight to 95% by weight, more preferably from 50% by weight to 90% by weight, still more preferably from 60% by weight to 85% by weight with respect to the total toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters, and montanic acid esters. However, the release agent of the exemplary embodiment is not limited thereto.

The melting temperature of the release agent is preferably from 50° C. to 110° C., and more preferably from 60° C. to 100° C.

Moreover, the melting temperature is determined by “a melting peak temperature” described in a method for determining a melting temperature of “transition temperature measuring method of plastic” in JIS K7121-1987 from a DSC curve obtained by differential scanning calorimetry (DSC).

The content of the release agent, for example, is preferably from 1% by weight to 20% by weight, and more preferably from 5% by weight to 15% by weight with respect to the total toner particles.

Other Additives

As other additives, known additives such as a magnetic material, a charge-controlling agent, inorganic powder, and the like maybe exemplified. The toner particles contain these additives as an internal additive.

Characteristics of Toner

Average Maximum Thickness C and Average Equivalent Circle Diameter D

As shown in (1), in the toner according to the exemplary embodiment, it is preferable that the average equivalent circle diameter D of the toner is larger than the average maximum thickness C of the toner. Furthermore, the ratio (C/D) of the average maximum thickness C to the average equivalent circle diameter D is preferably within a range from 0.001 to 0.500, more preferably from 0.010 to 0.200, and particularly preferably from 0.050 to 0.100.

When the ratio (C/D) is equal to or greater than 0.001, strength of the toner is ensured, fracture due to stress at the time of image formation is prevented, and charge due to exposure of the pigment is reduced, and as a result, fogging generated is prevented. On the other hand, when the ratio (C/D) is equal to or less than 0.500, excellent brilliance is obtained.

The average maximum thickness C and the average equivalent circle diameter D are measured by the following method.

The toner is placed on a smooth surface, and vibrated so as to be evenly dispersed. Regarding 1,000 particles of the toner, the maximum thickness C and the equivalent circle diameter D of a surface viewed from above are measured at 1,000 times magnification using a color laser microscope “VK-9700” (manufactured by Keyence Corporation), and by determining the arithmetic average value thereof, the average maximum thickness C and the average equivalent circle diameter are calculated.

Angle Between Long Axis Direction on Cross Section of Toner and Long Axis Direction of Metallic Pigment

As shown in (2), in a case where a cross section in the thickness direction of the toner is observed, the number of a metallic pigment in which an angle between the long axis direction on a cross section of the toner and the long axis direction of the metallic pigment is within a range from −30° to +30° is preferably equal to or greater than 60% in the entire metallic pigments observed. Furthermore, the above number is preferably from 70% to 95%, and particularly preferably from 80% to 90%.

When the above number is equal to or greater than 60%, excellent brilliance is obtained.

Here, a method for observing a cross section of the toner will be described.

After the toner is embedded with a bisphenol A-type liquid epoxy resin and a curing agent, a sample for cutting is manufactured. Then, the sample for cutting is cut at −100° C. using a cutting machine (LEICA ultra-microtome (manufactured by Hitachi High-Technologies Corporation) is used in the exemplary embodiment) with a diamond knife, whereby a sample for observation is manufactured. The sample for observation is magnified at about 5,000 times with a transmission electron microscope (TEM), and the cross-section of the toner is observed. Regarding 1,000 particles of the toner observed, the number of a metallic pigment in which an angle between the long axis direction on a cross section of the toner and the long axis direction of the metallic pigment is within a range from −30° to +30° is counted using image analysis software, and the proportion is calculated.

Furthermore, “the long axis direction on a cross section of the toner” represents the direction perpendicular to the thickness direction of the toner in which the average equivalent circle diameter D is larger than the average maximum thickness C, and “the long axis direction of the metallic pigment” represents the long direction of the metallic pigment.

In addition, the volume average particle diameter of the toner according to the exemplary embodiment is preferably from 1 μm to 30 μm, and more preferably 3 μm to 20 μm.

Moreover, regarding the volume average particle diameter D₅₀ᵥ, cumulative distributions by volume and by number are drawn from the side of the smallest diameter with respect to particle size ranges (channels) separated based on the particle size distribution measured using a measuring instrument such as a Coulter Multisizer II (manufactured by Beckman Coulter, Inc.), and the particle diameter when the cumulative percentage becomes 16% is defined as that corresponding to a volume particle diameter D₁₆ᵥ and a number particle diameter D₁₆ₚ, while the particle diameter when the cumulative percentage becomes 50% is defined as that corresponding to a volume average particle diameter D₅₀ᵥ and a number average particle diameter D₅₀ₚ, and the particle diameter when the cumulative percentage becomes 84% is defined as that corresponding to a volume particle diameter D₈₄ᵥ and a number particle diameter D₈₄ₚ. Using these, a volume average particle size distribution index (GSDv) is calculated as (D₈₄ᵥ/D₁₆ᵥ)^{1/2}.

The toner according to the exemplary embodiment may be prepared by adding an external additive to toner particles, if necessary, after the toner particles are prepared.

The preparation method of the toner particles is not particularly limited, and the toner particles are prepared by a dry method such as a known kneading and pulverizing method, or a wet method such as an emulsion aggregating method or a dissolution and suspension method. In the exemplary embodiment, the emulsion aggregating method in which a shell layer for preventing exposure of the specific aluminum pigment on the toner particle surface is easily formed is preferable.

That is, the preparation method of the toner according to the exemplary embodiment preferably includes a pigment dispersion preparation step of preparing a dispersion of the specific aluminum pigment which may be coated with a resin, an aggregated particle forming step of forming aggregated particles including the aluminum pigment using the dispersion, and a coating layer forming step of providing at least two layers of coating layer including a binder resin on the surfaces of the aggregated particles. In the preparation method of the toner according to the exemplary embodiment may include other steps, if necessary.

The emulsion aggregating method according to the exemplary embodiment may further have an emulsifying step of forming resin particles (emulsified particles) or the like by emulsifying raw materials configuring the toner particles, and a coalescence step of coalescing the aggregated particles on which coating layers are provided.

Pigment Dispersion Preparation Step

In the pigment dispersion preparation step, a dispersion of the specific aluminum pigment which may be coated with a resin is prepared. The dispersion may be prepared by a maker of the toner, or may be prepared by purchasing a commercially available product.

As a method for preparing of a dispersion of the specific aluminum pigment which is not coated with a resin, it is possible to use known dispersion methods, and for example, it is possible to employ generally used dispersing methods such as a rotary shearing-type homogenizer, a ball mill having media, a sand mill, a dyno mill, and an ultimizer, however, there is no limitation thereto. The specific aluminum pigment is dispersed with a polymer electrolyte such as an ionic surfactant, a polymer acid, and a polymer base in water. The volume average particle diameter of the dispersed specific aluminum pigment may be equal to or less than 20 μm, and when the volume average particle diameter is within a range from 3 μm to 16 μm, aggregability is not impaired and dispersing of the specific aluminum pigment in the toner is good, and thus, it is preferable.

In addition, the specific aluminum pigment and the resin with which the specific aluminum pigment is coated are dispersed and dissolved in a solvent to be mixed, and the mixture is dispersed in water by phase inversion emulsification or shear emulsification, and thus, a dispersion of the specific aluminum pigment coated with a resin is prepared.

Examples of the resin with which the specific aluminum pigment is coated include an acrylic resin, a polyester resin, and a polystyrene resin. Among these, from the viewpoint of improving encapsulation of a metallic pigment into the toner in case of using a polyester resin as a binder resin, an acrylic resin is preferable.

The coating amount of a resin in a case where the specific aluminum pigment is coated with the resin is preferably from 5.5 parts by weight to 9.0 parts by weight, more preferably from 6.0 parts by weight to 8.5 parts by weight, and still more preferably from 6.5 parts by weight to 8.0 parts by weight with respect to 100 parts by weight of the specific aluminum pigment.

As materials other than a solvent or the like used in preparation of a dispersion of the specific aluminum pigment coated with a resin, the same materials as those in the case of the emulsifying step described below may be exemplified.

Emulsifying Step

In preparation of the resin particle dispersion, a general polymerization method, for example, an emulsion polymerization method, a suspension polymerization method, or a dispersion polymerization method is used, and in addition, emulsification may be performed by applying a shear force to a solution obtained by mixing an aqueous medium and a binder resin by a disperser. At that time, particles may be formed by reducing the viscosity of the resin component by heating. In addition, a dispersant maybe used to stabilize the dispersed resin particles. Furthermore, if the resin is oily and is dissolved in a solvent having a relatively low solubility in water, the resin is particle-dispersed in water with a dispersant or a polymer electrolyte by dissolving in the solvent of the resin, and by evaporating the solvent by heating or reducing pressure, a resin particle dispersion is prepared.

Examples of the aqueous medium include water such as distilled water and ion exchange water, and alcohols, and among these, water is preferable.

In addition, examples of the dispersant used in the emulsifying step include water-soluble polymers such as polyvinyl alcohol, methyl cellulose, ethyl cellulose, hydroxyethyl cellulose, carboxymethyl cellulose, sodium polyacrylate, and poly(sodium methacrylate); surfactants including anionic surfactants such as sodium dodecylbenzene sulfonate, sodium octadecyl sulfate, sodium oleate, sodium laurate, and potassium stearate, cationic surfactants such as lauryl amine acetate, stearyl amine acetate, and lauryl trimethyl ammonium chloride, ampholytic surfactants such as lauryl dimethyl amine oxide, and nonionic surfactants such as polyoxyethylene alkyl ether, polyoxyethylene alkyl phenyl ether, and polyoxyethylene alkyl amine; and inorganic salts such as tricalcium phosphate, aluminum hydroxide, calcium sulfate, calcium carbonate, and barium carbonate.

Examples of the disperser used for the preparation of the emulsion include a homogenizer, a homomixer, a pressure kneader, an extruder, and a media disperser. As the resin particle size, the average particle diameter (volume average particle diameter) is preferably equal to or less than 1.0 μm, more preferably in a range from 60 nm to 300 nm, and still more preferably in a range from 150 nm to 250 nm. When the particle size is equal to or greater than 60 nm, the resin particles are likely to be unstable in a dispersion, and thus, there is a case where aggregation of the resin particles is easy. In addition, when the particle size is equal to or less than 1.0 μm, there is a case where the particle diameter distribution of the toner becomes narrow.

In the preparation of the release agent dispersion, after a release agent is dispersed with a polymer electrolyte such as an ionic surfactant, a polymer acid, and a polymer base in water, heating is performed to a temperature higher than the melting temperature of the release agent, and a dispersion treatment is performed using a homogenizer or a pressure discharging-type disperser by which a strong shearing force is imparted. Through such a treatment, the release agent dispersion may be obtained. When performing the dispersion treatment, inorganic compounds such as poly aluminum chloride may be added to the dispersion. Examples of the preferable inorganic compound include poly aluminum chloride, aluminum sulfate, highly basic poly aluminum chloride (BAC), poly aluminum hydroxide, and aluminum chloride. Among these, poly aluminum chloride and aluminum sulfate are preferable.

By the dispersion treatment, a release agent dispersion including release agent particles having a volume average particle diameter equal to or less than 1 μm is obtained. Moreover, a more preferable volume average particle diameter of the release agent particles is from 100 nm to 500 nm.

When the volume average particle diameter is equal to or greater than 100 nm, in general, the release agent component is likely to be incorporated in the toner, though this is also affected by the characteristics of the binder resin used. In addition, when the volume average particle diameter is equal to or less than 500 nm, the dispersion state of the release agent in the toner becomes good.

Aggregated Particle Forming Step

In the aggregated particle forming step, using a dispersion of the specific aluminum pigment and if necessary, a resin particle dispersion or a release agent dispersion, aggregated particles including the specific aluminum pigment are formed. The aggregated particles configure core particles in the toner particles through the coalescence step described below.

In the aggregated particle forming step, it is preferable that a dispersion of the specific aluminum pigment and if necessary, a resin particle dispersion or a release agent dispersion, and the like be mixed to make a mixed solution, and the mixed solution be heated at a temperature equal to or lower than the glass transition temperature of the resin particles to aggregate, and thereby, aggregated particles be formed. In many cases, formation of the aggregated particles is performed by acidifying pH of the mixed solution while stirring. It is possible to make the ratio (C/D) be within the preferred range by the stirring conditions described above. More specifically, it is possible to reduce the ratio (C/D) by stirring at a high speed and heating at the stage of forming the aggregated particles, and it is possible to increase the ratio (C/D) by stirring at a lower speed and heating at a lower temperature. Moreover, as the pH, a range from 2 to 7 is preferable, and at this time, the use of a coagulant is also effective.

In addition, in the aggregated particle forming step, the release agent dispersion may be added and mixed at once together with various dispersions such as a resin particle dispersion and the like, and may be added by dividing into several times.

As the coagulant, a surfactant having opposite polarity to that of the surfactant used in the above-described dispersant, inorganic metal salts, and a divalent or higher metal complex may be suitably used. In particular, in a case of using the metal complex, it is possible to reduce the amount of surfactant used and improve the charging characteristics, it is particularly preferable.

As the inorganic metal salts, in particular, aluminum salts and polymers thereof are suitable. In order to obtain a narrower particle size distribution, as the valence of the inorganic metal salt, a divalent inorganic metal salt is better than a monovalent inorganic metal salt, a trivalent inorganic metal salt is better than a divalent inorganic metal salt, and a tetravalent inorganic metal salt is better than a trivalent inorganic metal salt, and even if the valence is the same, a polymer-type inorganic metal salt polymer is more suitable.

In the exemplary embodiment, it is preferable to use a polymer of a tetravalent inorganic metal salt including aluminum in order to obtain a narrower particle size distribution.

Coating Layer Forming Step

In the coating layer forming step, at least two coating layers including a binder resin on the surfaces of the aggregated particles described above are preferably provided. The coating layer configures a shell layer in the toner particles through the coalescence step described below.

In the aggregated particle forming step, by additionally adding the resin particle dispersion after the diameter of the aggregated particles becomes a desired particle diameter, aggregated particles of which the surfaces are coated with a resin are formed. Since at least two coating layers are provided, it is preferable that additional addition of the resin particle dispersion be performed at least twice. When the coating layers are provided on the surfaces of the aggregated particles, the toner particles are configured to have the core particles through the coalescence step described below and the shell layer with which the core particles are coated. Therefore, the aluminum pigment included in the core particles is less likely to be further exposed on the toner surface, and thus, the configuration is preferable from the viewpoint of a charging property and a transfer property. In a case of additionally adding the resin particle dispersion, before the additional addition, a coagulant may be added, or pH adjustment may be performed.

The first additionally added amount of the resin particle dispersion with respect to the aggregated particles, for example, is preferably from 1 part by weight to 6 parts by weight, more preferably from 2 parts by weight to 5 parts by weight, and still more preferably from 3 parts by weight to 4 parts by weight by the amount of solid content of the resin in the resin particle dispersion with respect to 100 parts by weight of the aggregated particles.

The total of the additionally added amount of the resin particle dispersion with respect to the aggregated particles, for example, is preferably from 5 parts by weight to 50 parts by weight, more preferably from 10 parts by weight to 40 parts by weight, and still more preferably from 15 parts by weight to 30 parts by weight by the amount of solid content of the resin in the resin particle dispersion with respect to 100 parts by weight of the aggregated particles.

In the coating layer forming step, it is preferable to form a coating layer while heating at a temperature equal to or lower than the glass transition temperature of the resin particles. The heating condition for forming the coating layer is preferably from a temperature 16.5° C. lower than the glass transition temperature of the resin particles to a temperature 12° C. lower than the glass transition temperature of the resin particles, and more preferably from a temperature 16° C. lower than the glass transition temperature of the resin particles to a temperature 15° C. lower than the glass transition temperature of the resin particles.

In a case where using two or more types of resins having different glass transition temperatures as a resin forming a coating layer, as the heating condition at the time of forming the coating layer, the heating condition may be within the above range by the relationship with the glass transition temperature of any one resin of the two or more types of resins.

Coalescence Step

In the coalescence step, by adjusting pH of the suspension of the aggregated particles on which coating layers are provided to a range from 3 to 9 under the stirring conditions conforming to the coating layer forming step, the progress of the aggregation is stopped, and by heating to a temperature equal to or higher than the glass transition temperature of the resin, the aggregated particles are coalesced.

The heating may be performed until coalescence occurs, and the heating time may be from about 0.5 hours to about 10 hours.

By cooling after coalescence, coalesced particles are obtained. In addition, in the cooling step, crystallization may be promoted by dropping the cooling rate near the glass transition temperature of the resin (range of the glass transition temperature ±10° C.), that is, performing a so-called slow cooling.

The coalesced particles obtained by coalescence are made to be toner particles through a solid-liquid separation step such as filtration, or a cleaning step or a drying step if necessary.

The inorganic particles represented by silica, titania, and aluminum oxide may be added and attached to the obtained toner particles for the purpose of charge control, fluidity imparting, charge exchangeability imparting, or the like.

For example, these are performed by a V-type blender, a Henschel mixer, a lodige mixer, or the like, and the attachment may be performed by dividing into several stages. The amount added of an external additive is preferably a range from 0.1 parts by weight to 5 parts by weight, and more preferably a range from 0.3 parts by weight to 2 parts by weight with respect to 100 parts by weight of the toner particles.

In addition, in addition to the inorganic oxides described above, other components (particles) such as a charge-controlling agent, organic particles, a lubricant, and an abrasive may be added as an external additive.

The charge-controlling agent is not particularly limited, and a colorless or light-colored charge-controlling agent is preferably used. Examples thereof include a quaternary ammonium salt compound, a nigrosine compound, aluminum, a complex of chromium or the like, and a triphenylmethane pigment.

Examples of the organic particles include particles usually used as an external additive of a toner surface such as a vinyl resin, a polyester resin, and a silicone resin. Moreover, these inorganic particles or organic particles are used as a fluidity assistant, a cleaning activator, or the like.

Examples of the lubricant include fatty acid amides such as ethylene bisstearic amide and oleic amide, and fatty acid metal salts such as zinc stearate and calcium stearate.

Examples of the abrasive include the above-described silica, alumina, cerium oxide, and the like.

Electrostatic Charge Image Developer

The electrostatic charge image developer according to the exemplary embodiment includes at least the toner according to the exemplary embodiment.

The electrostatic charge image developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coating carrier in which surfaces of cores formed of a magnetic particle are coated with a coating resin; a magnetic particle dispersion-type carrier in which magnetic particles are dispersed and blended in a matrix resin; a resin impregnation-type carrier in which a porous magnetic particle is impregnated with a resin; and a resin dispersion-type carrier in which conductive particles are dispersed and blended in a matrix resin.

Moreover, the magnetic particle dispersion-type carrier, the resin impregnation-type carrier, and the conductive particle dispersion-type carrier may be carriers in which constituent particles of the carrier are cores and have a surface coated with a coating resin.

Examples of the magnetic particle include iron oxide, magnetic metals such as nickel and cobalt, and magnetic oxides such as ferrite and magnetite.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

Moreover, the coating resin and the matrix resin may include other additives such as a conductive material.

Here, a coating method using a coating layer forming solution in which a coating resin and, if necessary, various additives are dissolved in a suitable solvent is used to coat the surface of a core with the coating resin. The solvent is not particularly limited, and may be selected in consideration of the type of coating resin to be used, coating suitability, and the like.

Specific examples of the resin coating method include a dipping method for dipping cores in a coating layer forming solution; a spraying method for spraying a coating layer forming solution to surfaces of cores; a fluid bed method for spraying a coating layer forming solution in a state in which cores are allowed to float by flowing air; and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100, and more preferably from 3:100 to 20:100 (toner:carrier).

Image Forming Apparatus/Image Forming Method

The image forming apparatus and an image forming method according to the exemplary embodiment will be described.

The image forming apparatus according to the exemplary embodiment is equipped with an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium. In addition, as the electrostatic charge image developer, the electrostatic charge image developer according to the exemplary embodiment is applied.

In the image forming apparatus according to the exemplary embodiment, an image forming method (image forming method according to the exemplary embodiment) including charging a surface of an image holding member, forming an electrostatic charge image on a charged surface of the image holding member, developing the electrostatic charge image formed on the surface of the image holding member with the electrostatic charge image developer according to the exemplary embodiment to form a toner image, transferring the toner image formed on the surface of the image holding member onto a surface of a recording medium, and fixing the toner image transferred onto the surface of the recording medium is performed.

As the image forming apparatus according to the exemplary embodiment, a known image forming apparatus is applied, such as a direct transfer-type apparatus that directly transfers a toner image formed on a surface of an image holding member onto a recording medium; an intermediate transfer-type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus that is provided with a cleaning unit that cleans a surface of an image holding member after transfer of a toner image and before charging; or an apparatus that is provided with an erasing unit that irradiates, after transfer of a toner image and before charging, a surface of an image holding member with erasing light for erasing.

In the case where the image forming apparatus according to the exemplary embodiment is an intermediate transfer-type apparatus, a transfer unit has, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

Moreover, in the image forming apparatus according to the exemplary embodiment, for example, a part including the developing unit may have a cartridge structure (process cartridge) that is detachable from the image forming apparatus. As the process cartridge, for example, a process cartridge that contains the electrostatic charge image developer according to the exemplary embodiment and is equipped with a developing unit is suitably used.

Hereinafter, an example of the image forming apparatus according to the exemplary embodiment will be described. However, this image forming apparatus is not limited thereto. The major portions shown in the drawing will be described, but descriptions of other portions will be omitted.

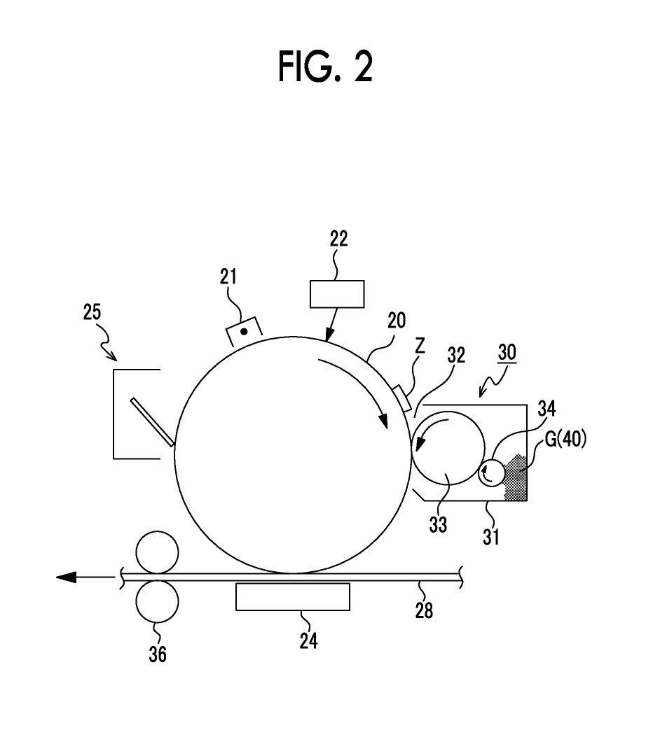

FIG. 2 is a schematic configuration view showing an exemplary embodiment of the image forming apparatus including a developing machine to which the electrostatic charge image developer according to the embodiment is applied.

In the same figure, the image forming apparatus according to the exemplary embodiment has a photoconductor drum 20 as an image holding member which rotates in the predetermined direction, and around the photoconductor drum 20, a charging device 21 for charging the photoconductor drum 20, an electrostatic charge image forming apparatus for forming electrostatic charge image Z on the photoconductor drum 20, for example an exposure device 22, a developing machine 30 for visualize the electrostatic charge image Z formed on the photoconductor drum 20, a transfer device 24 for transferring the toner image visualized on the photoconductor drum 20 to the recording sheet 28 which is a recording medium, and a cleaning device 25 for cleaning the residual toner on the photoconductor drum 20 are arranged sequentially.

In the exemplary embodiment, the developing machine 30 has a developing housing 31 in which a developer G including a toner 40 is accommodated as shown in FIG. 2, and in the developing housing 31, an opening for development 32 is provided so as to face the photoconductor drum 20 and a developing roller 33 (developing electrode) is arranged as a toner holding member facing the opening for development 32, and by applying a predetermined developing bias to the developing roller 33, a development electric field is formed in a region (developing region) between the photoconductor drum and the developing roller 33. Furthermore, in the developing housing 31, a charge injection roller 34 (injection electrode) as a charge injection member facing the developing roller 33 is provided. In particular, in the exemplary embodiment, the charge injection roller 34 is also used as the toner supply roller for supplying the toner 40 to the developing roller 33.

Here, although the direction of rotation of the charge injection roller 34 may be arbitrarily selected, in consideration of the supply of the toner and charge injection characteristics, it is preferable that the charge injection roller 34 rotate in the same direction at the facing portion of the developing roller 33 and with a peripheral speed difference (for example, equal to or greater than 1.5 time), the toner 40 be sandwiched in a region between the charge injection roller 34 and the developing roller 33, and while being scraped, charge be injected.

Next, the operation of the image forming apparatus according to the exemplary embodiment will be described.

When an imaging process is started, first, the surface of the photoconductor drum 20 is charged by the charging device 21, then, the exposure device 22 write an electrostatic charge image Z on the charged photoconductor drum 20, and the developing machine 30 visualizes the electrostatic charge image Z as a toner image. Thereafter, the toner image on the photoconductor drum 20 is transported to a transfer portion, and the transfer device 24 electrostatically transfers the toner image on the photoconductor drum 20 to the recording sheet 28 which is a recording medium. Furthermore, the residual toner on the photoconductor drum. 20 is cleaned by the cleaning device 25. After this, the toner image on the recording sheet 28 is fixed by the fixing device 36, whereby an image is obtained.

Process Cartridge/Toner Cartridge

The process cartridge according to the exemplary embodiment will be described.

The process cartridge according to the exemplary embodiment is equipped with a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing machine, and if necessary, at least one selected from other units such as an image holding member, a charging unit, an electrostatic charge image forming unit, and a transfer unit.

Hereinafter, an example of the process cartridge according to the exemplary embodiment will be shown. However, this process cartridge is not limited thereto. The major portions shown in the drawing will be described, but descriptions of other portions will be omitted.

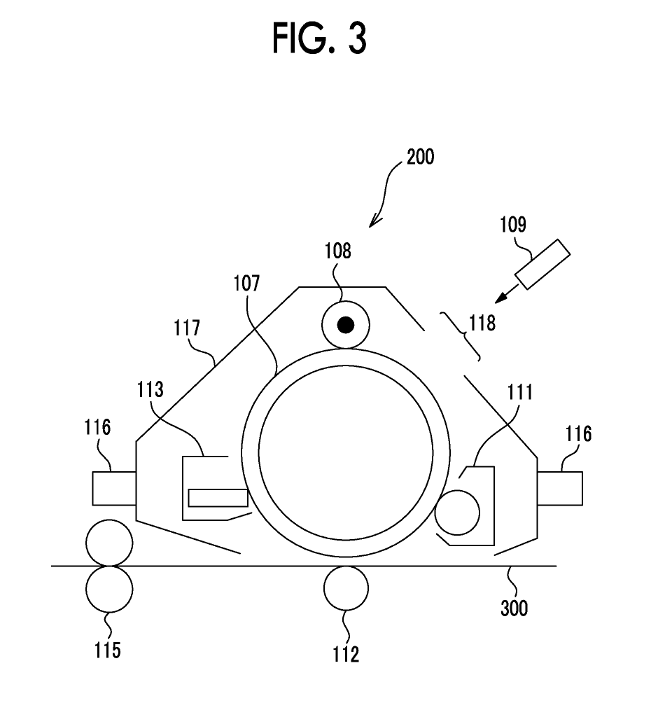

FIG. 3 is a schematic diagram showing the process cartridge according to the exemplary embodiment.

A process cartridge 200 shown in FIG. 3 is formed as a cartridge having a configuration in which a photoconductor 107 (an example of the image holding member), a charging roller 108 (an example of the charging unit), a developing machine 111 (an example of the developing unit), and a photoconductor cleaning device 113 (an example of the cleaning unit), which are equipped around the photoconductor 107, are integrally combined and held by the use of, for example, a housing 117 equipped with a mounting rail 116 and an opening 118 for exposure.

In FIG. 3, a reference numeral 109 represents an exposure device (an example of the electrostatic charge image forming unit), a reference numeral 112 represents a transfer device (an example of the transfer unit), a reference numeral 115 represents a fixing device (an example of the fixing unit), and a reference numeral 300 represents a recording sheet (an example of the recording medium).

Next, the toner cartridge according to the exemplary embodiment will be described.

The toner cartridge according to the exemplary embodiment accommodates the toner according to the exemplary embodiment and may be configured so as to be detachable from the image forming apparatus. Moreover, in the toner cartridge according to the exemplary embodiment, at least a toner may be accommodated, and depending on the mechanism of the image forming apparatus, for example, a developer may be accommodated.

Moreover, the image forming apparatus shown in FIG. 2 has a configuration in which the toner cartridges (not shown) are detachable therefrom, and the developing machine 30 is connected to the toner cartridges and toner supply tubes not shown. In addition, in a case where the toner accommodated in the toner cartridge runs low, the toner cartridge may be replaced.

### Example

Hereinafter, the exemplary embodiment will be more specifically described with reference to Examples and Comparative Examples, but the exemplary embodiment is not limited to the following Examples. Moreover, “parts” and “%” are based on weight unless specified otherwise.

### Example 1

### Synthesis of Binder Resin 1

Bisphenol A propylene oxide 2 moles adduct: 469 parts
Bisphenol A ethylene oxide 2 moles adduct: 137 parts
Terephthalic acid: 152 parts
Fumaric acid: 75 parts
Dodecenyl succinic acid: 114 parts
Dibutyl tin oxide: 4 parts

After the above components are put into a three-neck flask dried by heating, the air in the container is evacuated by a decompression operation, furthermore, an inert atmosphere is formed by a nitrogen gas, and the mixture is allowed to react at 230° C. and at atmospheric pressure (101.3 kPa) for 10 hours by mechanical stirring and further allowed to react at 8 kPa for 1 hour. After cooling to 210° C., 4 parts of trimellitic anhydride are added thereto, then, the resultant product is allowed to react for 1 hour, and the resultant product is allowed to react at 8 kPa until the softening temperature reaches 107° C., whereby a binder resin 1 is obtained. The glass transition temperature of the binder resin 1 is 63.5° C.

Moreover, using a flow tester (CFT-5000 manufactured by Shimadzu Corporation), a load of 1.96 MPa is applied by a plunger while heating a sample of 1 g at a heating rate of 6° C./min, thereby the sample is extruded from a nozzle having a diameter of 1 mm and a length of 1 mm, and the temperature when a half amount of the sample is flowed out is taken as the softening temperature of the resin.

The glass transition temperature of the binder resin 1 is measured based on JIS K7121-1987 using a differential scanning calorimeter (DSC 3110 manufactured by Mac Science Inc., a thermal analysis system 001). For temperature correction of a detection portion of the apparatus, the melting point of a mixture of indium and zinc is used, and for correction of the quantity of heat, the heat of fusion of indium is used. The sample is placed on an aluminum pan, then, the aluminum pan on which the sample is placed and an empty aluminum pan for comparison is set, and a measurement is performed at a heating rate of 10° C./min.

In addition, a temperature at an intersection point of extension lines of a baseline and a rising line in an endothermic portion of the DSC curve obtained by the measurement is taken as the glass transition temperature.

### Synthesis of Binder Resin 2

A binder resin 2 is obtained in the same manner as in the binder resin 1 except that the amount of monomer components are changed as follows, and the softening temperature at the time of withdrawing a resin is changed to 118° C. The glass transition temperature of the binding resin 2 is 90.5° C.
Bisphenol A propylene oxide adduct: 367 parts
Bisphenol A ethylene oxide adduct: 230 parts
Terephthalic acid: 163 parts
Trimellitic anhydride: 20 parts
Fumaric acid: 12 parts
Dodecenyl succinic acid: 227 parts
Dibutyl tin oxide: 4 parts

### Preparation of Resin Particle Dispersion 1

Binder resin 1: 300 parts
Methyl ethyl ketone: 150 parts
Isopropanol: 50 parts
10% ammonia aqueous solution: 10.6 parts

After the above components (after removing insoluble matter with respect to the binder resin) are put into a separable flask, mixed, and dissolved, ion exchange water is added dropwise thereto at a liquid supply rate 8 parts/min using a liquid supply pump while heat and stirring at 40° C. After the liquid became cloudy, the liquid supply rate is increased to 12 parts/min to cause a phase inversion, and dropping is stopped when the supply amount reached 1050 parts. Thereafter, the solvent is removed under a reduced pressure, whereby a resin particle dispersion 1 is obtained. The volume average particle diameter of the resin particle dispersion 1 is 165 nm, and the solid content concentration is 30.6%.

### Preparation of Resin Particle Dispersion 2

A resin particle dispersion 2 is obtained in the same manner as in the resin particle dispersion 1 except that the type of binder resin is changed to the binder resin 2, and the amounts of methyl ethyl ketone, isopropanol, and ammonia water are changed as follows. The volume average particle diameter of the resin particle dispersion 2 is 164 nm, and the solid content concentration is 30.6%.
Methyl ethyl ketone: 218 parts
Isopropanol: 60 parts
10% ammonia aqueous solution: 10.6 parts

### Preparation of Crystalline Resin Particle Dispersion

After 225 parts of 1,10-dodecanedioic acid, 160 parts of 1,9-nonanediol, and 0.8 parts of dibutyl tin oxide as a catalyst are put into a three-neck flask dried by heating, the air in the three-neck flask is substituted with nitrogen gas by a decompression operation to form an inert atmosphere, and by stirring the mixture at 180° C. for 5 hours by mechanical stirring and refluxing, a reaction proceeded. During the reaction, the water formed in the reaction system is distilled off. Thereafter, the temperature is slowly raised to 230° C. under a reduced pressure, stirring is performed for two hours, then, when the reaction product became a viscous state, a molecular weight is checked by GPC, and when the weight average molecular weight became 29,000, vacuum distillation is stopped, whereby a crystalline polyester resin is obtained.

Then, 100 parts of the crystalline polyester resin, 40 parts of methyl ethyl ketone, and 30 parts of isopropyl alcohol are put into a separable flask, and after the mixture is thoroughly mixed and dissolved at 75° C., 6.0 parts of 10% ammonia aqueous solution are added dropwise thereto.

The heating temperature is lowered to 60° C., then, ion exchange water is added dropwise thereto at a liquid supply rate 6 parts/min using a liquid supply pump while stirring, and after the liquid became cloudy, the liquid supply rate is increased to 25 parts/min, and dropping of ion exchange water is stopped when the total amount of liquid reached 400 parts. Then, the solvent is removed under a reduced pressure, whereby a crystalline resin particle dispersion is obtained. The volume average particle diameter of the obtained crystalline resin particle dispersion is 168 nm, and the solid content concentration is 11.5%.

### Preparation of Release Agent Dispersion

Paraffin wax HNP9 (manufactured by Nippon Seiro Co., Ltd.): 500 parts
Anionic surfactant (manufactured by Dai-ichi Kogyo Seiyaku Co., Ltd., NEOGEN RK): 50 parts
Ion exchange water: 1700 parts

A mixture of the above components is heated to 110° C., and after the mixture is dispersed using a homogenizer (Ultra Turrax T50 manufactured by IKA Japan, K.K.), the mixture is subjected to a dispersion treatment using a manton gaulin high pressure homogenizer (manufactured by Gaulin), whereby a release agent dispersion (release agent concentration: 31.1%) formed by dispersing a release agent having an average grain diameter of 0.18 μm is prepared.

### Preparation of Metallic Pigment Dispersion 1

Aluminum pigment (2173EA (trade name) manufactured by Toyo Aluminium K.K.): 100 parts
Silica (AEROSIL 130 manufactured by Aerosil Nippon Co., Ltd.): 20 parts
25% solution of polymethyl methacrylate (manufactured by Soken Chemical & Engineering Co., Ltd., weight average molecular weight of 20,000) in toluene: 4 parts

The above components are put into a high speed mixer (“Nobilta NOB-130” manufactured by Hosokawa Micron Group) with a stirring blade and mixed by stirring at 50° C. for 1 hour while rotating the stirring blade at 2,000 rpm, then, the solvent is distilled off, and the mixture is further mixed by stirring at 50° C. for 30 minutes while rotating the stirring blade at 2,000 rpm, whereby a mixture in which silica is attached to an aluminum pigment is prepared.
Anionic surfactant (manufactured by Dai-ichi Kogyo Seiyaku Co., Ltd., NEOGEN R): 1.5 parts
Ion exchange water: 1080 parts

The above mixture and the above components are mixed, and the mixture is dispersed for about 1 hour using an emulsifying disperser Cavitron (CR1010 manufactured by Pacific Machinery & Engineering Co., Ltd.), whereby a metallic pigment dispersion 1 (solid content concentration: 10%) formed by dispersing metallic pigment particles (aluminum pigment) is prepared.

### Preparation of Metallic Pigment Dispersion 2

The metallic pigment dispersion 2 is prepared in the same method as in the metallic pigment dispersion 1 except that the amount of silica in Preparation of Metallic pigment Dispersion 1 is changed to 17.5 parts and the amount of ion exchange water is changed to 1057.5 parts.

### Preparation of Metallic Pigment Dispersion 3

The metallic pigment dispersion 3 is prepared in the same method as in the metallic pigment dispersion 1 except that the amount of silica in Preparation of Metallic pigment Dispersion 1 is changed to 16.5 parts and the amount of ion exchange water is changed to 1048.5 parts.

### Preparation of Metallic Pigment Dispersion 4

The metallic pigment dispersion 4 is prepared in the same method as in the metallic pigment dispersion 1 except that the amount of silica in Preparation of Metallic pigment Dispersion 1 is changed to 20.8 parts and the amount of ion exchange water is changed to 1087.2 parts.

### Preparation of Metallic Pigment Dispersion 5

The metallic pigment dispersion 5 is prepared in the same method as in the metallic pigment dispersion 1 except that the amount of silica in Preparation of Metallic pigment Dispersion 1 is changed to 21.7 parts and the amount of ion exchange water is changed to 1095.3 parts.

### Preparation of Metallic pigment Dispersion 6

The metallic pigment dispersion 6 is prepared in the same method as in the metallic pigment dispersion 1 except that the amount of the 25% solution of polymethyl methacrylate in toluene in Preparation of Metallic pigment Dispersion 1 is changed to 40 parts.

### Preparation of Toner

Resin particle dispersion 1: 250 parts
Resin particle dispersion 2: 250 parts
Crystalline resin particle dispersion: 116 parts
Release agent dispersion: 62 parts
Metallic pigment dispersion 1: 270 parts
Nonionic surfactant (IGEPAL CA897): 1.40 parts

The above materials are put into a 2-liter cylindrical container, and the materials are dispersed and mixed for 10 minutes while applying a shearing force at 4000 rpm by a homogenizer (Ultra Turrax T50 manufactured by IKA Japan, K.K.). Then, 1.75 parts of 10% nitric acid aqueous solution of polyaluminum chloride as an aggregating agent are added dropwise thereto, and the mixture is dispersed and mixed for 15 minutes at a rotation rate of 5000 rpm of the homogenizer, whereby a raw material dispersion is obtained.

Thereafter, the raw material dispersion is transferred to a polymerization tank equipped with a stirrer using two paddle stirring blades for forming a laminar flow and a thermometer, then, heated in a mantle heater at a stirring rate of 857 rpm, and the temperature is adjusted to 54° C. to promote growth of aggregated particles. In addition, at this time, a pH of the raw material dispersion is controlled to a range from 2.2 to 3.5 with 0.3 N nitric acid or 1 N sodium hydroxide aqueous solution. The raw material dispersion is kept within the above pH range for about 2 hours, whereby aggregated particles are formed.

Then, 25.5 parts of the resin particle dispersion 1 is additionally added thereto, and after being kept for 30 minutes, 160.5 parts of the resin particle dispersion 2 is additionally added thereto, whereby resin particles of the binder resin are attached to the surface of the aggregated particles.

Thereafter, the temperature is raised to 56° C., and aggregated particles are adjusted while checking the size and shape of particles using an optical microscope and Multisizer II. Thereafter, 4.25 parts of a chelating agent are added thereto (HIDS manufactured by Nippon Shokubai Co., Ltd.), then, a pH is adjusted to 7.8 using 5% sodium hydroxide aqueous solution, and the resultant product is kept for 15 minutes. Thereafter, the pH is raised to 8.0 to coalesce the aggregated particles, and the temperature is raised to 66.5° C. After it is checked that the aggregated particles are coalesced with an optical microscope, the pH is lowered to 6.0 with maintaining the temperature of 66.5° C., then, heating is stopped after 1 hour, and cooling is performed at a temperature cooling rate of 1.0° C./min. Thereafter, the resultant product is sieved with a 20 μm mesh, then, repeatedly washed with water, and dried in a vacuum dryer, whereby toner particles (toner 1) are obtained. The volume average particle diameter of the obtained toner 1 is 12.2 μm.

The ratio (A/B) of the toner 1 is 0.008.

1.5 parts of silica particles (RY 50 manufactured by Aerosil Nippon Co., Ltd.) is mixed with 100 parts of the toner 1 for 3 minutes at a peripheral speed of 30 m/sec using a Henschel mixer (manufactured by Mitsui Miike Machinery Co., Ltd.). Thereafter, the resultant product is sieved with a vibration sieving machine having a mesh of 45 μm, whereby the toner (1) is prepared.

### Preparation of Carrier

Ferrite particles (volume average particle diameter: 35 μm): 100 parts
Toluene: 14 parts
Perfluoroacrylate copolymer (critical surface tension: 24 dyn/cm): 1.6 parts
Carbon black (trade name: VXC-72, manufactured by Cabot Corporation, volume resistivity: equal to or less than 100 Ωcm): 0.12 parts
Crosslinked melamine resin particles (average particle diameter: 0.3 μm, insoluble in toluene): 0.3 parts

First, carbon black diluted with toluene is added to a perfluoroacrylate copolymer, and the mixture is dispersed using a sand mill. Then, in the resultant product, the above respective components other than ferrite particles are dispersed using a stirrer for 10 minutes, and a solution for forming a coating layer is formulated. Then, the solution for forming a coating layer and ferrite particles are put into a vacuum deaeration-type kneader, and after stirring at 60° C. for 30 minutes, the toluene is distilled off by reducing the pressure, and a resin coating layer is formed, whereby a carrier is obtained.

### Preparation of Developer

36 parts of the toner and 414 parts of the carrier are put into a 2-liter V-blender, then, the mixture is stirred for 20 minutes, and sieved with a 212 μm mesh, whereby a developer is prepared.

Evaluation

Electrical Characteristics

In the exemplary embodiment, the measured values of a dielectric loss rate are values obtained by a method in which the toner is press-formed for 2 minutes under 98067 kPa (1000 Kgf/cm²) so as to become a disk shape having a diameter of 50 mm and a thickness of 3 mm, and after the resultant product is kept for 17 hours in an atmosphere of 40° C. and a relative humidity of 50% and further kept for 17 hours in an atmosphere of 28° C. and a relative humidity of 85%, a dielectric loss is measured.

The measurement is performed under the conditions of 1000 Hz, 5.0V by setting a test sample to an electrode for solid (SE-71 type manufactured by Ando Electric Co., Ltd.) having an electrode diameter of 38 mm and by using a dielectric measurement system 126096W type manufactured by Solartron Technology. The obtained results are shown in Table 1.

Transfer Efficiency

In the evaluation of transfer efficiency, a developer is put into a yellow developing device, then, patches of 5 cm×5 cm are drawn on C2 paper manufactured by Fuji Xerox Co., Ltd. in the environment of 32° C., 80% RH using a remodeled ApeosPort-II C4300 (which has a configuration in which if the yellow developing device contains a developer, operation is performed even when other developing device does not contain a developer, and the photoconductor after development and the paper before fixing are arbitrarily taken out) manufactured by Fuji Xerox Co., Ltd., and the weight of each toner is measured after drawing on 10,000 pieces of paper, and when the transfer efficiency obtained by the following expression is equal to or greater than 80%, it is evaluated as an acceptable level.

Transfer efficiency=(toner on paper before fixing)/(toner on photoconductor after development)×100(%)

Moreover, the toner on the photoconductor after development is measured by the difference in weight before and after blow-off of the toner on the photoconductor after the photoconductor after development is taken out, and the toner on the paper before fixing is measured by the difference in weight before and after blow-off of the toner on the paper after the paper before fixing is taken out. The obtained results are shown in Table 1.

Brilliance of Image

In a case where arrangement of a brilliant pigment configuring an image is irregular even if the transfer efficiency is good, brilliance is lowered in some cases. In particular, in a case where a large amount of the resin is coated, the amount of the coating resin is increased with respect to the brilliant pigment in the toner, and particles which did not include the brilliant pigment is relatively increased, and irregular arrangement as described above is likely to occur in some cases, and thus, evaluation is visually performed. Evaluation sample is an image used in Transfer Efficiency described above, and the transfer efficiency thereof is equal to or greater than 80%. Evaluation is performed according to the following criteria. The obtained results are shown in Table 1.

A: Problem in brilliance is not observed.

B: There is a somewhat irregular impression in brilliance.

C: Brilliance is slightly low, however, it is acceptable.

### Example 2

A toner and a developer are prepared in the same manner as in Example 1 except that the amount of the resin particle dispersion 1 and the amount of the resin particle dispersion 2 additionally added, in the method for preparing a toner described in Example 1, are changed to 26.2 parts and 102.1 parts, respectively.

Evaluation is performed in the same manner as in Example 1 using the obtained toner and developer. The results are shown in Table 1.

### Example 3

A toner and a developer are prepared in the same manner as in Example 1 except that the amount of the resin particle dispersion 1 and the amount of the resin particle dispersion 2 additionally added in the method for preparing a toner described in Example 1 are changed to 31.3 parts and 224.8 parts, respectively.

Evaluation is performed in the same manner as in Example 1 using the obtained toner and developer. The results are shown in Table 1.

### Example 4

A toner and a developer are prepared in the same manner as in Example 1 except that the amount of the resin particle dispersion 1 and the amount of the resin particle dispersion 2 additionally added in the method for preparing a toner described in Example 1 are changed to 21.6 parts and 102.5 parts, respectively.

Evaluation is performed in the same manner as in Example 1 using the obtained toner and developer. The results are shown in Table 1.

### Example 5

A toner and a developer are prepared in the same manner as in Example 1 except that the amount of the resin particle dispersion 1 and the amount of the resin particle dispersion 2 additionally added in the method for preparing a toner described in Example 1 are changed to 25.7 parts and 225.2 parts, respectively.

Evaluation is performed in the same manner as in Example 1 using the obtained toner and developer. The results are shown in Table 1.

### Example 6

A toner and a developer are prepared in the same manner as in Example 1 except that the amount of the resin particle dispersion 1 and the amount of the resin particle dispersion 2 additionally added in the method for preparing a toner described in Example 1 are changed to 28.3 parts and 104.8 parts, respectively.

Evaluation is performed in the same manner as in Example 1 using the obtained toner and developer. The results are shown in Table 1.

### Example 7

A toner and a developer are prepared in the same manner as in Example 1 except that the amount of the resin particle dispersion 1 and the amount of the resin particle dispersion 2 additionally added in the method for preparing a toner described in Example 1 are changed to 33.8 parts and 230.9 parts, respectively.

Evaluation is performed in the same manner as in Example 1 using the obtained toner and developer. The results are shown in Table 1.

### Example 8

A toner and a developer are prepared in the same manner as in Example 1 except that the amount of the resin particle dispersion 1 and the amount of the resin particle dispersion 2 additionally added in the method for preparing a toner described in Example 1 are changed to 27.0 parts and 102.5 parts, respectively.

Evaluation is performed in the same manner as in Example 1 using the obtained toner and developer. The results are shown in Table 1.

### Example 9

A toner and a developer are prepared in the same manner as in Example 1 except that the amount of the resin particle dispersion 1 and the amount of the resin particle dispersion 2 additionally added in the method for preparing a toner described in Example 1 are changed to 34.5 parts and 282.8 parts, respectively.

Evaluation is performed in the same manner as in Example 1 using the obtained toner and developer. The results are shown in Table 1.

### Example 10

A toner and a developer are prepared in the same manner as in Example 1 except that the amount of the resin particle dispersion 1 and the amount of the resin particle dispersion 2 additionally added in the method for preparing a toner described in Example 1 are changed to 22.2 parts and 102.8 parts, respectively.

Evaluation is performed in the same manner as in Example 1 using the obtained toner and developer. The results are shown in Table 1.

### Example 11

A toner and a developer are prepared in the same manner as in Example 1 except that the amount of the resin particle dispersion 1 and the amount of the resin particle dispersion 2 additionally added in the method for preparing a toner described in Example 1 are changed to 28.3 parts and 283.0 parts, respectively.

Evaluation is performed in the same manner as in Example 1 using the obtained toner and developer. The results are shown in Table 1.

### Example 12

A toner and a developer are prepared in the same manner as in Example 1 except that the amount of the resin particle dispersion 1 and the amount of the resin particle dispersion 2 additionally added in the method for preparing a toner described in Example 1 are changed to 19.7 parts and 106.8 parts, respectively.

Evaluation is performed in the same manner as in Example 1 using the obtained toner and developer. The results are shown in Table 1.

### Example 13

A toner and a developer are prepared in the same manner as in Example 1 except that the amount of the resin particle dispersion 1 and the amount of the resin particle dispersion 2 additionally added in the method for preparing a toner described in Example 1 are changed to 23.4 parts and 234.5 parts, respectively.

Evaluation is performed in the same manner as in Example 1 using the obtained toner and developer. The results are shown in Table 1.

### Example 14

A toner and a developer are prepared in the same manner as in Example 1 except that the amount of the resin particle dispersion 1 and the amount of the resin particle dispersion 2 additionally added in the method for preparing a toner described in Example 1 are changed to 32.9 parts and 69.9 parts, respectively.

Evaluation is performed in the same manner as in Example 1 using the obtained toner and developer. The results are shown in Table 1.

### Example 15

A toner and a developer are prepared in the same manner as in Example 1 except that the amount of the resin particle dispersion 1 and the amount of the resin particle dispersion 2 additionally added in the method for preparing a toner described in Example 1 are changed to 49.2 parts and 389.4 parts, respectively.

Evaluation is performed in the same manner as in Example 1 using the obtained toner and developer. The results are shown in Table 1.

### Example 16

A toner and a developer are prepared in the same manner as in Example 1 except that the amount of the resin particle dispersion 1 and the amount of the resin particle dispersion 2 additionally added in the method for preparing a toner described in Example 1 are changed to 14.8 parts and 68.6 parts, respectively.

Evaluation is performed in the same manner as in Example 1 using the obtained toner and developer. The results are shown in Table 1.

### Example 17

A toner and a developer are prepared in the same manner as in Example 1 except that the amount of the resin particle dispersion 1 and the amount of the resin particle dispersion 2 additionally added in the method for preparing a toner described in Example 1 are changed to 21.8 parts and 376.6 parts, respectively.

Evaluation is performed in the same manner as in Example 1 using the obtained toner and developer. The results are shown in Table 1.

### Example 18

A toner and a developer are prepared in the same manner as in Example 1 except that the metallic pigment dispersion 4 is used, and the amount of the resin particle dispersion 1 and the amount of the resin particle dispersion 2 additionally added in the method for preparing a toner described in Example 1 are changed to 36.6 parts and 71.8 parts, respectively.

Evaluation is performed in the same manner as in Example 1 using the obtained toner and developer. The results are shown in Table 1.

### Example 19

A toner and a developer are prepared in the same manner as in Example 1 except that the metallic pigment dispersion 3 is used, and the amount of the resin particle dispersion 1 and the amount of the resin particle dispersion 2 additionally added in the method for preparing a toner described in Example 1 are changed to 54.9 parts and 400.8 parts, respectively.

Evaluation is performed in the same manner as in Example 1 using the obtained toner and developer. The results are shown in Table 1.

### Example 20

A toner and a developer are prepared in the same manner as in Example 1 except that the metallic pigment dispersion 4 is used, and the amount of the resin particle dispersion 1 and the amount of the resin particle dispersion 2 additionally added in the method for preparing a toner described in Example 1 are changed to 33.9 parts and 69.1 parts, respectively.

Evaluation is performed in the same manner as in Example 1 using the obtained toner and developer. The results are shown in Table 1.

### Example 21

A toner and a developer are prepared in the same manner as in Example 1 except that the metallic pigment dispersion 3 is used, and the amount of the resin particle dispersion 1 and the amount of the resin particle dispersion 2 additionally added in the method for preparing a toner described in Example 1 are changed to 54.6 parts and 478.2 parts, respectively.

Evaluation is performed in the same manner as in Example 1 using the obtained toner and developer. The results are shown in Table 1.

### Example 22

A toner and a developer are prepared in the same manner as in Example 1 except that the metallic pigment dispersion 5 is used, and the amount of the resin particle dispersion 1 and the amount of the resin particle dispersion 2 additionally added in the method for preparing a toner described in Example 1 are changed to 15.2 parts and 67.8 parts, respectively.

Evaluation is performed in the same manner as in Example 1 using the obtained toner and developer. The results are shown in Table 1.

### Example 23

A toner and a developer are prepared in the same manner as in Example 1 except that the metallic pigment dispersion 2 is used, and the amount of the resin particle dispersion 1 and the amount of the resin particle dispersion 2 additionally added in the method for preparing a toner described in Example 1 are changed to 24.1 parts and 67.8 parts, respectively.

Evaluation is performed in the same manner as in Example 1 using the obtained toner and developer. The results are shown in Table 1.

### Example 24

A toner and a developer are prepared in the same manner as in Example 1 except that the metallic pigment dispersion 5 is used, and the amount of the resin particle dispersion 1 and the amount of the resin particle dispersion 2 additionally added in the method for preparing a toner described in Example 1 are changed to 12.6 parts and 67.8 parts, respectively.

Evaluation is performed in the same manner as in Example 1 using the obtained toner and developer. The results are shown in Table 1.

### Example 25

A toner and a developer are prepared in the same manner as in Example 1 except that the metallic pigment dispersion 2 is used, and the amount of the resin particle dispersion 1 and the amount of the resin particle dispersion 2 additionally added in the method for preparing a toner described in Example 1 are changed to 40.5 parts and 36.3 parts, respectively.

Evaluation is performed in the same manner as in Example 1 using the obtained toner and developer. The results are shown in Table 1.

### Example 26

A toner and a developer are prepared in the same manner as in Example 1 except that the metallic pigment dispersion 4 is used, and the amount of the resin particle dispersion 1 and the amount of the resin particle dispersion 2 additionally added in the method for preparing a toner described in Example 1 are changed to 40.5 parts and 36.3 parts, respectively.

Evaluation is performed in the same manner as in Example 1 using the obtained toner and developer. The results are shown in Table 1.

### Example 27

A toner and a developer are prepared in the same manner as in Example 1 except that the metallic pigment dispersion 2 is used, and the amount of the resin particle dispersion 1 and the amount of the resin particle dispersion 2 additionally added in the method for preparing a toner described in Example 1 are changed to 14.8 parts and 590.8 parts, respectively.

Evaluation is performed in the same manner as in Example 1 using the obtained toner and developer. The results are shown in Table 1.

### Example 28

A toner and a developer are prepared in the same manner as in Example 1 except that the metallic pigment dispersion 4 is used, and the amount of the resin particle dispersion 1 and the amount of the resin particle dispersion 2 additionally added in the method for preparing a toner described in Example 1 are changed to 44.0 parts and 36.9 parts, respectively.

Evaluation is performed in the same manner as in Example 1 using the obtained toner and developer. The results are shown in Table 1.

### Example 29

A toner and a developer are prepared in the same manner as in Example 1 except that the metallic pigment dispersion 2 is used, and the amount of the resin particle dispersion 1 and the amount of the resin particle dispersion 2 additionally added in the method for preparing a toner described in Example 1 are changed to 16.3 parts and 705.7 parts, respectively.

Evaluation is performed in the same manner as in Example 1 using the obtained toner and developer. The results are shown in Table 1.

### Example 30

A toner and a developer are prepared in the same manner as in Example 1 except that the metallic pigment dispersion 2 is used, and the amount of the resin particle dispersion 1 and the amount of the resin particle dispersion 2 additionally added in the method for preparing a toner described in Example 1 are changed to 10.0 parts and 598.5 parts, respectively.

Evaluation is performed in the same manner as in Example 1 using the obtained toner and developer. The results are shown in Table 1.

### Comparative Example 1

A toner and a developer are prepared in the same manner as in Example 1 except that the metallic pigment dispersion 4 is used, and the amount of the resin particle dispersion 1 and the amount of the resin particle dispersion 2 additionally added in the method for preparing a toner described in Example 1 are changed to 41.0 parts and 33.9 parts, respectively.

Evaluation is performed in the same manner as in Example 1 using the obtained toner and developer. The results are shown in Table 1.

### Example 31

A toner and a developer are prepared in the same method as in Example 1 except that the metallic pigment dispersion 6 is used, in the method for preparing a toner described in Example 1.

Evaluation is performed in the same manner as in Example 1 using the obtained toner and developer. The evaluation results are shown in Table 1.

### Example 32

A toner and a developer are prepared in the same method as in Example 1 except that after being kept at 54° C. for 2 hours, the temperature after additionally adding is 60° C., in the method for preparing a toner described in Example 1.

Evaluation is performed in the same manner as in Example 1 using the obtained toner and developer. The evaluation results are shown in Table 1.

TABLE 1

| | A/B | Transfer | Dielectric | |
|---|---|---|---|---|
| | [Si %/C %] | efficiency | loss rate | |
| | (XPS) | (%) | (×10⁻³) | Brilliance |
| Example 1 | 0.008 | 93 | 20 | A |
| Example 2 | 0.009 | 92 | 30 | A |
| Example 3 | 0.006 | 94 | 15 | A |
| Example 4 | 0.009 | 92 | 32 | A |
| Example 5 | 0.006 | 94 | 18 | A |
| Example 6 | 0.009 | 92 | 31 | B |
| Example 7 | 0.006 | 94 | 17 | B |
| Example 8 | 0.01 | 89 | 32 | B |
| Example 9 | 0.005 | 95 | 14 | B |
| Example 10 | 0.011 | 89 | 33 | B |
| Example 11 | 0.005 | 95 | 15 | B |
| Example 12 | 0.009 | 92 | 33 | B |
| Example 13 | 0.006 | 94 | 18 | B |
| Example 14 | 0.016 | 87 | 38 | B |
| Example 15 | 0.004 | 96 | 10 | B |
| Example 16 | 0.019 | 87 | 43 | B |
| Example 17 | 0.004 | 96 | 12 | B |
| Example 18 | 0.019 | 86 | 37 | C |
| Example 19 | 0.004 | 96 | 10 | C |
| Example 20 | 0.021 | 84 | 38 | C |
| Example 21 | 0.004 | 97 | 9 | C |
| Example 22 | 0.022 | 84 | 43 | C |
| Example 23 | 0.004 | 97 | 12 | C |
| Example 24 | 0.022 | 86 | 45 | C |
| Example 25 | 0.005 | 96 | 12 | C |
| Example 26 | 0.03 | 82 | 45 | C |
| Example 27 | 0.004 | 97 | 8 | C |
| Example 28 | 0.028 | 81 | 45 | C |
| Example 29 | 0.003 | 97 | 6 | C |
| Example 30 | 0.004 | 97 | 8 | C |
| Comparative | 0.042 | 78 | 56 | — |
| Example 1 | | | | |
| Example 31 | 0.008 | 93 | 20 | B |
| Example 32 | 0.008 | 93 | 21 | A |

From Examples and Comparative Examples, the above facts are found. The toner of the exemplary embodiment is excellent in a charging property and a transfer property in addition to the original brilliance. In contrast, a toner in which the ratio (A/B) of a content A (atom %) of a Si element of toner particles to a content B (atom %) of a C element of toner particles measured by X-ray photoelectron spectroscopy (XPS) is great and departing from the application range is poor in a charging property and a transfer property. In addition, although there is a tendency that the brilliance of the toner in which the coating with the brilliant pigment is increased are lowered, this is within an acceptable range.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner, comprising:
toner particles containing an aluminum pigment that is coated with silica and a binder resin,
wherein the following formula is satisfied:
A/B≦0.040
where A represents a content (atom %) of a Si element of the toner particles and B represents a content (atom %) of a C element of the toner particles, A and B being measured by X-ray photoelectron spectroscopy (XPS).

2. The electrostatic charge image developing toner according to claim 1,
wherein the following formula is satisfied:
2≦X/Y≦100
where X represents a reflectance at a light-receiving angle of +30° and Y represents a reflectance at a light-receiving angle of −30°, X and Y being measured when a solid image formed by the toner is irradiated with an incident light having an incident angle of −45° using a goniophotometer.

3. The electrostatic charge image developing toner according to claim 1,
wherein an average maximum thickness of the toner is defined as C and an average equivalent circle diameter of the toner is defined as D, D is larger than C.

4. The electrostatic charge image developing toner according to claim 3,
wherein a ratio (C/D) of the average maximum thickness C to the average equivalent circle diameter D is from 0.001 to 0.500.

5. The electrostatic charge image developing toner according to claim 1,
wherein in a case where a cross section in the thickness direction of the toner is observed, a number of a metallic pigment in which an angle between the long axis direction on a cross section of the toner and the long axis direction of the metallic pigment is within a range from −30° to +30° is equal to or greater than 60% in the entirety of metallic pigments observed.

6. The electrostatic charge image developing toner according to claim 1,
wherein in the aluminum pigment, a coating amount of silica with respect to the aluminum pigment is from 16 parts by weight to 22 parts by weight with respect to 100 parts by weight of the aluminum pigment.

7. The electrostatic charge image developing toner according to claim 6,
wherein a coating thickness of silica with respect to the aluminum pigment is from 1.5 nm to 5.0 nm.

8. The electrostatic charge image developing toner according to claim 6,
wherein the pigment is an aluminum pigment in which silica is mechanically implanted into the surface.

9. The electrostatic charge image developing toner according to claim 6,
wherein the pigment is an aluminum pigment of which the surface is coated with silica and further coated with a resin.

10. The electrostatic charge image developing toner according to claim 1,
wherein a volume average particle diameter of the aluminum pigment is from 3 μm to 20 μm.

11. The electrostatic charge image developing toner according to claim 1,
wherein a content of the aluminum pigment is from 1 part by weight to 70 parts by weight with respect to 100 parts by weight of the binder resin.

12. The electrostatic charge image developing toner according to claim 1,
wherein the binder resin is a polyester resin.

13. The electrostatic charge image developing toner according to claim 12,
wherein a glass transition temperature (Tg) of the polyester resin is from 50° C. to 80° C.

14. The electrostatic charge image developing toner according to claim 12,
wherein a weight average molecular weight (Mw) of the polyester resin is from 5,000 to 1,000,000.

15. The electrostatic charge image developing toner according to claim 12,
wherein a molecular weight distribution Mw/Mn of the polyester resin is from 1.5 to 100.

16. The electrostatic charge image developing toner according to claim 1,
wherein a content of the binder resin is from 40% by weight to 95% by weight with respect to the entirety of toner particles.

17. The electrostatic charge image developing toner according to claim 1,
wherein a volume average particle diameter is from 1 μm to 30 μm.

18. The electrostatic charge image developing toner according to claim 1, which has a core shell structure having at least two or more coating layers.

19. An electrostatic charge image developer, comprising:
the electrostatic charge image developing toner according to claim 1.

20. A toner cartridge which accommodates the electrostatic charge image developing toner according to claim 1 and is detachable from an image forming apparatus.
